(19) United States
(12) Patent Application Publication
(10) Pub. No.: US 2013/0136346 A1
(43) Pub. Date: May 30, 2013

(54) COMPUTING DEVICE, STORAGE MEDIUM AND METHOD FOR PROCESSING FOREGROUND COLOR OF IMAGE

(71) Applicants: JEN-HSIUNG CHARNG, Tu-Cheng (TW); MING-CHUAN KAO, Tu-Cheng (TW)

(72) Inventors: JEN-HSIUNG CHARNG, Tu-Cheng (TW); MING-CHUAN KAO, Tu-Cheng (TW)

(73) Assignee: HON HAI PRECISION INDUSTRY CO., LTD., Tu-Cheng (TW)

(21) Appl. No.: 13/479,274

(22) Filed: May 24, 2012

(30) Foreign Application Priority Data
Nov. 25, 2011 (CN) 201110380594.X

(51) Int. Cl. G06K 9/00

(52) U.S. Cl. 382/162

(57) ABSTRACT

In a method of a computing device for processing a foreground color of an image, pixels of the image are sampled according to a predetermined sampling ratio. An RGB value of each sampled pixel of the image is counted, and an ideal pixel value of each of the R value, the G value and the B value is determined. A background color of the image is selected from a predetermined color palette according to the ideal pixel value of each of the R value, the G value and the B value. A complementary color of the background color is calculated. A foreground color of the image is selected from the color palette according to the complementary color.

### BACKGROUND

1. Technical Field

Embodiments of the present disclosure relate to the field of image processing, and more particularly to a computing device, a storage medium and a method for processing foreground color of an image.

2. Description of Related Art

When a user processes an image, the user may insert text, graphs, or lines having an eye-catching foreground color in the image. Usually, the user selects the foreground color by experience, for example, if a background color of the image is cyan, the user may select red as the foreground color of the image. However, if the image includes a variety of background colors, it is inconvenient for the user to select an appropriate foreground color for the image.

### BRIEF DESCRIPTION OF THE DRAWINGS

FIG. 1 is a block diagram of one embodiment of a computing device including a foreground color processing system.

FIG. 2 is a schematic diagram of one embodiment of a color palette.

FIG. 3 is a flowchart of one embodiment of a method for processing a foreground color of an image using the computing device of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

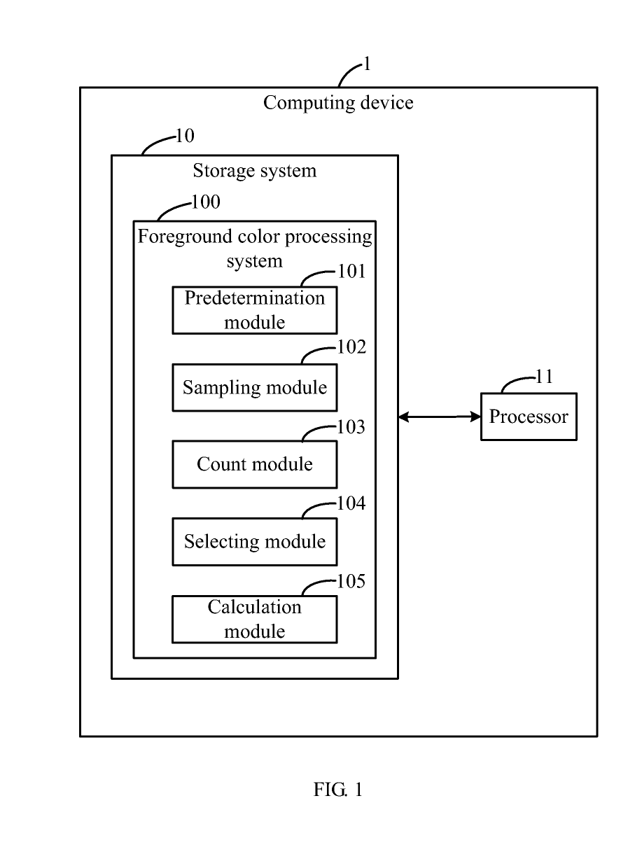

FIG. 1 is a block diagram of one embodiment of a computing device 1 including a foreground color processing system 100. In the embodiment, the computing device 1 further includes a storage system 10 and at least one processor 11. The storage system 10 stores at least one image, such as a picture or a painting. The image stored in the storage system 10 includes a variety of colors in an RGB color model. Each pixel of the image can be represented in form of an RGB value (R, G, B) that includes a red (R) value, a green (G) value, and a blue (B) value. In the embodiment, the RGB value may range from 0 to 255 (decimal number). FIG. 1 is just one example of the computing device 1 that can be included with more or fewer components than shown in other embodiments, or have a different configuration of the various components.

The foreground color processing system 100 may be in form of one or more programs that are stored in the storage system 10 and executed by the at least one processor 11. The foreground color processing system 100 can provide a foreground color for the image when the image is processed by inserting text, graphs, or lines into the image.

In one embodiment, the storage system 10 may be a random access memory (RAM) for temporary storage of information, and/or a read only memory (ROM) for permanent storage of information. In other embodiments, the storage system 10 may also be an external storage device, such as a hard disk, a storage card, or a data storage medium. The at least one processor 11 executes computerized operations of the computing device 1 to provide functions of the computing device 1.

In one embodiment, the foreground color processing system 100 may include a predetermination module 101, a sampling module 102, a count module 103, a selecting module 104, and a calculation module 105. The module 101-105 may comprise a plurality of functional modules each comprising one or more programs or computerized codes that are stored in the storage system 10 and executed by the at least one processor 11. In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

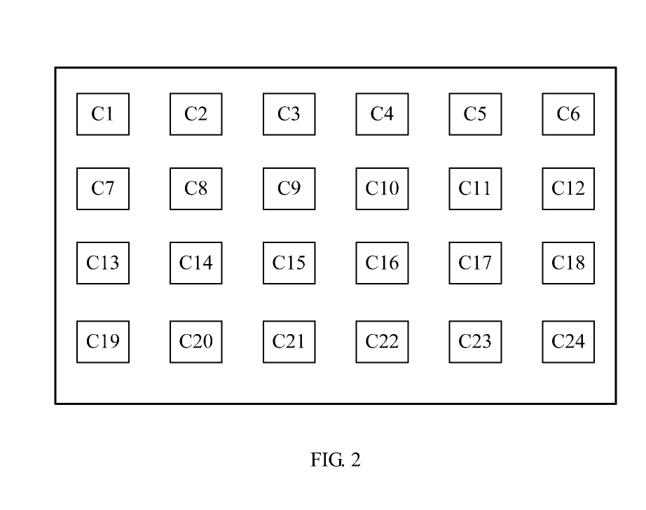

The predetermination module 101 predetermines a color palette that includes a plurality of colors in the RGB color model. Each of the colors in the color palette is also represented in form of an RGB value. The predetermination module 101 predetermines each of the colors in the color palette by predetermining the RGB values of the colors. For example, FIG. 2 is a schematic diagram of one embodiment of the color palette. In one embodiment, the color palette includes twenty-four colors C1, C2, . . . , and C24, and the RGB value of the color C1 is (255, 10, 10). The predetermination module 101 further predetermines a sampling ratio between a number of sampled pixels to a total number of pixels in the image. That is to say, the sampling ratio=(number of sampled pixels)/(total number of pixels in the image), such as 30%.

The sampling module 102 acquires the image from the storage system 10, and samples pixels from the image according to the predetermined sampling ratio. For example, if the total number of pixels in the image is one hundred and the sampling ratio is 30%, the sampling module 102 samples thirty pixels from the image according to the sampling ratio.

The count module 103 counts the RGB value of each sampled pixel of the image, and determines an ideal pixel value of each of the R value, the G value and the B value according to the counted RGB value of each sampled pixel of the image. The ideal pixel value is defined as a value that appears most frequently in the RGB value of each sampled pixel of the image. For example, the sampling module 102 samples ten pixels, and the RGB value of each sampled pixel is:

| | |
|---|---|
| \textcircled{1}RGB (255, 10, 23) | \textcircled{2}RGB (125, 108, 23) |
| \textcircled{3}RGB (125, 100, 130) | \textcircled{4}RGB (25, 125, 100) |
| \textcircled{5}RGB (125, 120, 25) | \textcircled{6}RGB (220, 120, 50) |
| \textcircled{7}RGB (95, 120, 23) | \textcircled{8}RGB (100, 10, 35) |
| \textcircled{9}RGB (60, 88, 72) | \textcircled{10}RGB (125, 120, 90) |

The count module 103 determines the value “125” as the ideal pixel value of the R value, determines the value “120” as the ideal pixel value of the G value, and determines the value “23” as the ideal pixel value of the B value.

The selecting module 104 selects a color from the color palette as a background color of the image according to the ideal pixel value of each of the R value, the G value and the B value. In the embodiment, the R value, the G value and the B value of the background color respectively equals or most approximates to the ideal pixel value of each of the R value, the G value and the B value.

The calculation module 105 calculates a complementary color of the background color. In one embodiment, the calculation module 105 calculates a difference between the decimal number “255” and the R value, a difference between the decimal number “255” and the G value, and a difference between the decimal number “255” and the B value of the background color. The calculation module 105 further determines the differences as the R value, the G value and the B value of the complementary color. For example, if the RGB value of the background is (255, 50, 125), the RGB value of the complementary color is (0, 205, 130).

The selecting module 104 further selects a color from the color palette as the foreground color of the image according to the complementary color, and stores the foreground color of the image to the storage system 10. In the embodiment, the R value, the G value and the B value of the foreground color respectively equals or most approximates to the R value, the G value and the B value of the complementary color.

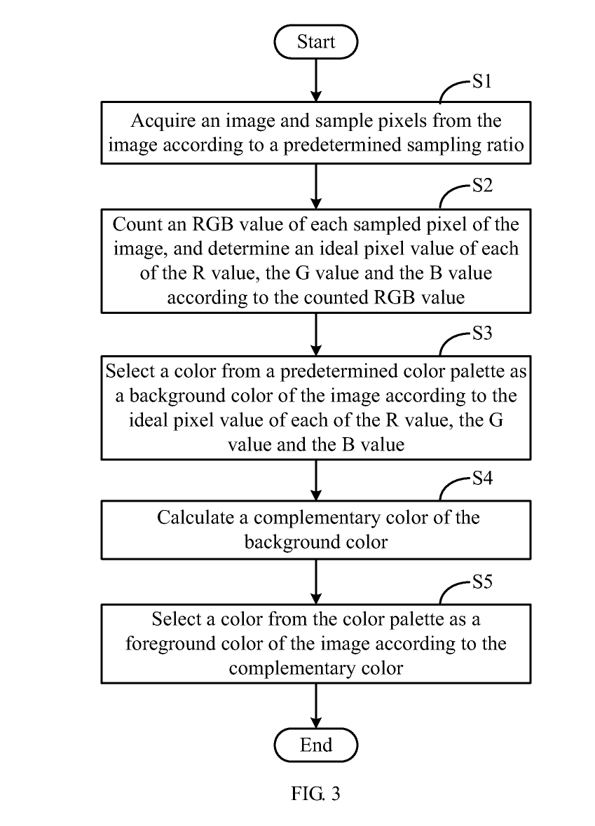

FIG. 3 is a flowchart of one embodiment of a method for processing a foreground color of an image using the computing device of FIG. 1. Depending on the embodiment, additional steps may be added, others removed, and the ordering of the steps may be changed.

Before step S1, the predetermination module 101 predetermines a color palette that includes a plurality of colors in an RGB color model. Each of the colors is represented in form of an RGB value. The predetermination module 101 predetermines each of the colors in the color palette by predetermining the RGB values of the colors. The predetermination module 101 further predetermines a sampling radio between a number of sampled pixels to a total number of pixels in an image, such as 30%.

In step S1, the sampling module 102 acquires an image from the storage system 10, and samples pixels from the image according to the predetermined sampling ratio.

In step S2, the count module 103 counts the RGB value of each sampled pixel of the image, and determines an ideal pixel value of each of the R value, the G value and the B value according to the counted the RGB value of each sampled pixel of the image. The ideal pixel value is defined as a value that appears most frequently in the RGB value of each sampled pixel of the image.

In step S3, the selecting module 104 selects a color from the color palette as a background color of the image according to the ideal pixel value of each of the R value, the G value and the B value. In one embodiment, the R value, the G value and the B value of the background color respectively equals or most approximates to the ideal pixel value of each of the R value, the G value and the B value.

In step S4, the calculation module 105 calculates a complementary color of the background color. In one embodiment, the calculation module 105 calculates a difference between the decimal number “255” and the R value, a difference between the decimal number “255” and the G value, and a difference between the decimal number “255” and the B value of the background color. The calculation module 105 further determines the differences as the R value, the G value and the B value of the complementary color.

In step S5, the selecting module 104 selects a color from the color palette as the foreground color of the image according to the complementary color, and stores the foreground color of the image to the storage system 10. In one embodiment, the R value, the G value and the B value of the foreground color respectively equals or most approximates to the R value, the G value and the B value of the complementary color.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A computing device, comprising:
a storage system;
at least one processor; and
one or more programs stored in the storage system and executed by the at least one processor, the one or more programs comprising:
a predetermination module that predetermines a color palette including a plurality of colors;
a sampling module that acquires an image from the storage system, and samples pixels from the image according to a predetermined sampling ratio, wherein the sampling ratio=(number of sampled pixels)/(total number of pixels in the image);
a count module that counts an RGB value of each sampled pixel of the image, and determines an ideal pixel value of each of the R value, the G value and the B value according to the counted RGB value;
a selecting module that selects a color from the color palette as a background color of the image according to the ideal pixel value of each of the R value, the G value and the B value;
a calculation module that calculates a complementary color of the background color;
the selecting module further selects a color from the color palette as a foreground color of the image according to the complementary color, and stores the foreground color of the image to the storage system.

2. The computing device of claim 1, wherein the predetermination module predetermines each of the colors in the color palette by predetermining the RGB values of the colors.

3. The computing device of claim 1, wherein the ideal pixel value of each of the R value, the G value and the B value respectively equals or most approximates to an R value, a G value and a B value of the background color.

4. The computing device of claim 1, wherein the calculation module calculates a difference between a decimal number “255” and the R value, a difference between the decimal number “255” and the G value, and a difference between the decimal number “255” and the B value of the background color, and determines the differences as the R value, the G value and the B value of the complementary color.

5. The computing device of claim 1, wherein the R value, the G value and the B value of the complementary color respectively equals or most approximates to an R value, a G value and a B value of the foreground color.

6. A method of a computing device for processing a foreground color of an image, the method comprising:
(a) predetermining a color palette that includes a plurality of colors;
(b) acquiring the image from a storage system of the computing device, and sampling pixels from the image according to a predetermined sampling ratio, wherein the sampling ratio=(number of sampled pixels)/(total number of pixels in the image);
(c) counting an RGB value of each sampled pixel of the image, and determining an ideal pixel value of each of the R value, the G value and the B value according to the counted RGB value;
(d) selecting a color from the color palette as a background color of the image according to the ideal pixel value of each of the R value, the G value and the B value;
(e) calculating a complementary color of the background color;
(f) selecting a color from the color palette as the foreground color of the image according to the complementary color, and storing the foreground color of the image to the storage system.

7. The method of claim 6, wherein the step (a) comprises:
predetermining each of the colors in the color palette by predetermining the RGB values of the colors.

8. The method of claim 6, wherein the ideal pixel value of each of the R value, the G value and the B value respectively equals or most approximates to an R value, a G value and a B value of the background color.

9. The method of claim 6, wherein the step (e) comprises:
calculating a difference between a decimal number “255” and the R value, calculating a difference between the decimal number “255” and the G value, and calculating a difference between the decimal number “255” and the B value of the background color; and
determining the differences as the R value, the G value and the B value of the complementary color.

10. The method of claim 6, wherein the R value, the G value and the B value of the complementary color respectively equals or most approximates to an R value, a G value and a B value of the foreground color.

11. A non-transitory storage medium storing a set of instructions, the set of instructions capable of being executed by a processor of a computing device, causes the computing device to execute a method for processing a foreground color of an image, the method comprising:
(a) predetermining a color palette that includes a plurality of colors;
(b) acquiring the image from a storage system of the computing device, and sampling pixels from the image according to a predetermined sampling ratio, wherein the sampling ratio=(number of sampled pixels)/(total number of pixels in the image);
(c) counting an RGB value of each sampled pixel of the image, and determining an ideal pixel value of each of the R value, the G value and the B value according to the counted RGB value;
(d) selecting a color from the color palette as a background color of the image according to the ideal pixel value of each of the R value, the G value and the B value;
(e) calculating a complementary color of the background color;
(f) selecting a color from the color palette as the foreground color of the image according to the complementary color, and storing the foreground color of the image to the storage system.

12. The storage medium of claim 11, wherein the step (a) comprises:
predetermining each of the colors in the color palette by predetermining the RGB values of the colors.

13. The storage medium of claim 11, wherein the ideal pixel value of each of the R value, the G value and the B value respectively equals or most approximates to an R value, a G value and a B value of the background color.

14. The storage medium of claim 11, wherein the step (e) comprises:
calculating a difference between a decimal number “255” and the R value, calculating a difference between the decimal number “255” and the G value, and calculating a difference between the decimal number “255” and the B value of the background color; and
determining the differences as the R value, the G value and the B value of the complementary color.

15. The storage medium of claim 11, wherein the R value, the G value and the B value of the complementary color respectively equals or most approximates to an R value, a G value and a B value of the foreground color.
